(19) United States
(12) Patent Application Publication
(10) Pub. No.: US 2019/0293143 A1
(43) Pub. Date: Sep. 26, 2019

(54) Cylinder Unit having a Scaled Bottom

(71) Applicant: ZF Friedrichshafen AG, Friedrichshafen (DE)

(72) Inventor: Andreas ALZER, Eitorf (DE)

(21) Appl. No.: 16/299,343

(22) Filed: Mar. 12, 2019

(30) Foreign Application Priority Data
Mar. 22, 2018 (DE) 10 2018 204 423.6

(51) Int. Cl. F16F 9/32; F15B 15/14

(52) U.S. Cl. CPC F16F 9/3242; F16F 2226/048; F15B 15/1438

(57) ABSTRACT

A cylinder unit includes a cylinder which is closed by a separate bottom. The cylinder is sealed by an annular seal which is accommodated in an annular groove. The annular seal is fixed to the cylinder by a disk element connected to the bottom. The bottom forms a first groove side surface of the annular groove, and the disk element forms a second groove side surface of the annular groove.

### 1. FIELD OF THE INVENTION

The present invention is directed to a cylinder unit with bottom having a seal accommodated in an annular groove.

### 2. BACKGROUND OF THE INVENTION

A vibration damper, the outer cylinder of which has a separate bottom connected to the cylinder via a positive engagement connection, is known from DE 10 2014 202 201 A1, the content of which is incorporated herein in its entirety by reference. To ensure sufficient tightness, a sealing ring is used which is accommodated in an annular groove of the bottom. A groove base and groove side surfaces are both formed by the bottom. Basically, this principle of construction has high loadability and tightness. A disadvantage consists in the comparatively short service life of the tool used for the bottom.

DE 10 2007 024 336 A1 describes a vibration damper with a welded-in bottom. The bottom forms a pressure-tight joint with the cylinder. In order to prevent dirt from entering, the bottom is outfitted with a disk-shaped component part which, together with an end region of the cylinder, forms a collecting space for dirt. A seal bounds the collecting space and is held by the disk-shaped component part. The seal need only perform a sealing function to prevent particles from penetrating for the time period during which welding is carried out. After the welding, the sealing function is no longer required. Therefore, the collecting space can also be provided with a through-opening which connects the collecting space to a gas space. In view of the merely limited demand for the sealing function, an annular groove in which the seal is accommodated is also not so meticulously constructed. Both the groove base and the groove side surfaces are formed by the disk-shaped component part.

An object of the present invention is to overcome the production problem known from the prior art relating to the annular groove.

### SUMMARY OF THE INVENTION

This object is met in that the bottom forms a first groove side surface of the annular groove and the disk element forms a second groove side surface of the annular groove.

The bottom is effectively divided into an outer bottom and an inner bottom such that there are, in each instance, open groove areas of the annular groove which can be produced very simply without radial offsets.

Advantageously, the disk element forms a groove base of the annular groove. The disk element has a lower material strength than the bottom or outer bottom. Consequently, there is less shaping effort for the thinner part than for the inner bottom. Further, a rather flat geometry is preferred on the outer side in order to facilitate welding of an annular eye to the bottom.

In designing the annular groove, it was determined that the preloading on the sealing ring is improved when the annular groove has a trapezoidal cross section.

For the purpose of a minimum possible material thickness of the disk element, it is provided that the disk element is connected over its entire surface area to the bottom radially inside a groove base of the annular groove. The outer bottom serves as supporting element for the disk element.

In a further advantageous configuration, the disk element is adapted to a conical inner profile of the bottom. This achieves several advantages. For one, the disk element is centered very easily relative to the outer bottom during assembly. On the other hand, a trapezoidal annular groove cross section can be achieved very simply in combination with the disk element through the conical inner profile which forms the groove side surface at the edges.

For the sake of a simple production of a constructional unit of outer bottom with inner bottom, the disk element comprises a weldable material and is at least spot welded to the bottom. The weld does not experience high loading, since an operating pressure inside of the cylinder unit brings about a hold-together force in the assembled state of the bottom. The welding need merely ensure that the outer bottom and inner bottom are held together for the duration of assembly.

Alternatively, the disk element can also be made of a plastic and connected to the bottom by spot fusion.

A further connection possibility is achieved in that the disk element has a through-opening which receives a solder volume for joining to the bottom.

The disk element preferably forms a constructional unit with the bottom via a positive engagement connection. A small thickness of the disk element favors the workability of the positive engagement connection.

In a cylinder unit which is constructed as a vibration damper with a bottom valve, it is possible to also fix the disk element to the bottom by fixing the bottom valve in the vibration damper. To this end, the bottom valve can be, e.g., beaded radially to the cylinder, or the bottom valve is held in connection with a piston rod guide inside a clamping chain via an inner compression tube.

### BRIEF DESCRIPTION OF THE DRAWINGS

The invention will be described in more detail referring to the following description of the figures in which:

FIG. 1 is a sectional view of a cylinder unit of the present invention;

FIG. 2 is an outer view of the cylinder unit according to FIG. 1;

FIG. 3 is a cross-sectional view of the bottom from FIG. 1 as detail;

FIG. 4 is a cross-sectional view of an alternative construction; and

FIG. 5 depicts a positive engagement connection between the bottom and the disk element.

### DETAILED DESCRIPTION OF THE PRESENTLY PREFERRED EMBODIMENTS

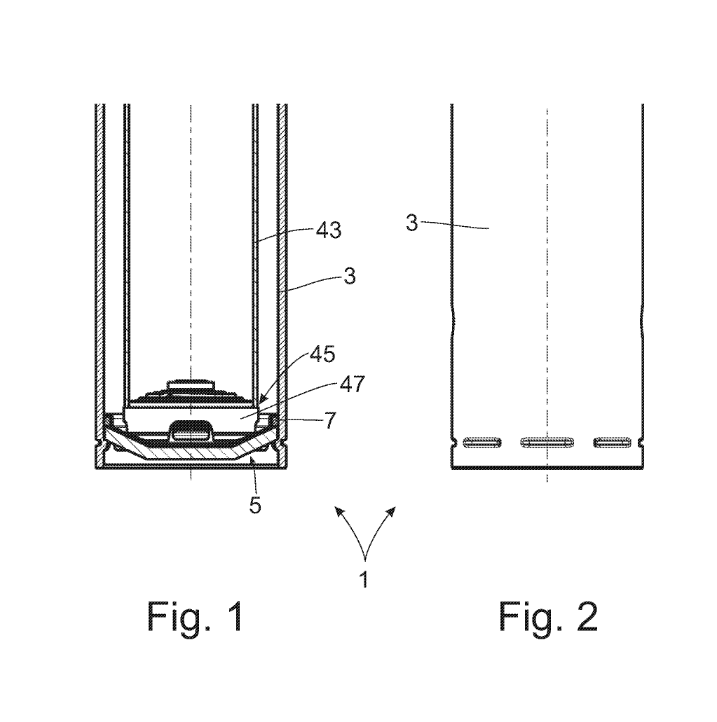

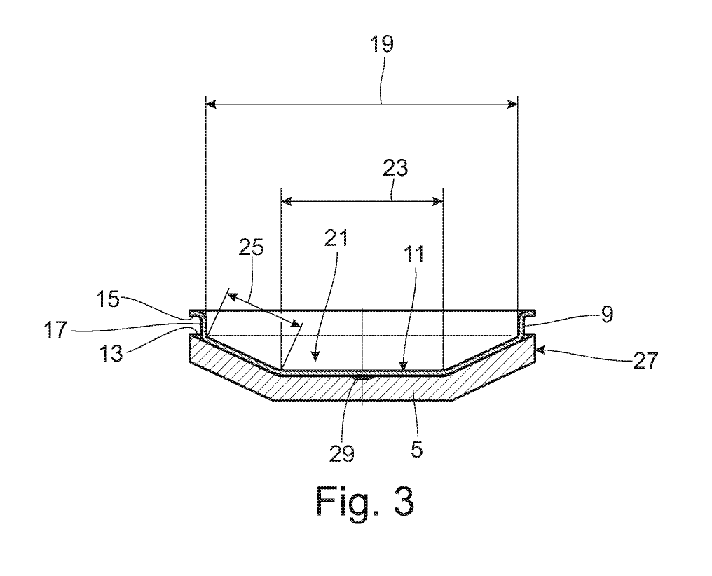

FIGS. 1 and 2 show a cylinder unit 1 such as is used, e.g., in the construction of a vibration damper or a gas spring. The invention is not limited to these two product groups. The cylinder unit comprises a cylinder 3 which is closed at the end by a separate bottom 5. A connection member, not shown, can be fastened to the bottom 5 on the outer side. By “separate” is meant that, before connecting to the cylinder 3, the bottom 5 forms an individual part that is independent from the cylinder 3 in contrast to a cylinder 3 which forms an integral component part with the bottom 5 through corresponding shaping steps.

The cylinder 3 is sealed by an annular seal 7 which is accommodated in an annular groove 9 (FIG. 3). The annular seal 7 is fixed to cylinder 3 and to bottom 5 by a disk element 11 which is connected to bottom 5. The annular groove 9 includes a first groove side surface 13, a second groove side surface 15 and a groove base 17. As is shown in particular by FIGS. 3 to 5, the bottom 5 forms the first groove side surface 13 of the annular groove 9 and the disk element 11 forms the second groove side surface 15 of the annular groove 9. The disk element 11 also forms the groove base 17 of the annular groove 9. A direct connection of the disk element 11 to the bottom 5 results in the complete annular groove 9 in which none of the aforementioned component parts 5; 11 need have a radial offset to form the annular groove 9. Consequently, the disk element 11 and the bottom 5 can be produced in a very simple manner.

As is shown by FIG. 3, inter alia, the annular groove 9 has a trapezoidal cross section and accordingly ensures a particularly advantageous preloading on the annular seal 7. The trapezoidal cross section is asymmetrical because groove side surface 15 extends at right angles to the groove base 17 and groove side surface 13 extends obliquely to the groove base 17.

The disk element 11 is connected over the entire surface area to bottom 5 radially inside of the groove base 17 so that there is a large contact surface and, therefore, supporting surface 19 available on the bottom 5.

As is further shown in FIG. 3, disk element 11 is adapted to a conical inner profile 21 of bottom 5 radially inside of the annular groove 9. The inner profile 21 comprises a planar central area 23 and an adjoining conical edge area 25. The conical edge area with a cone angle of between 20° and 35° and the horizontal groove side surface 15 to the trapezoidal cross section of the annular groove 9. The bottom 5 is centered inside of cylinder 3 via a circumferential lateral surface 27. The lateral surface 27 has a slightly larger outer diameter than the disk element so that the disk element need only absorb a holding force for the annular seal.

In many cases, the bottom is made of a metal material, e.g., steel. In one embodiment, the disk element likewise comprises a weldable material and is at least spot welded to the bottom. A weld nugget 29 is shown symbolically to facilitate understanding. The weld joint need only satisfy very minimal holding force requirements. It is most important that the weld joint withstands the assembly process from the joining of the two bottom parts to the installation of the bottom in cylinder 3.

Alternatively, the disk element 11 can be made of a plastic and is partially fused for the joining step so as to be glued to the bottom 5. In principle, the disk element 11 can also be glued to the bottom.

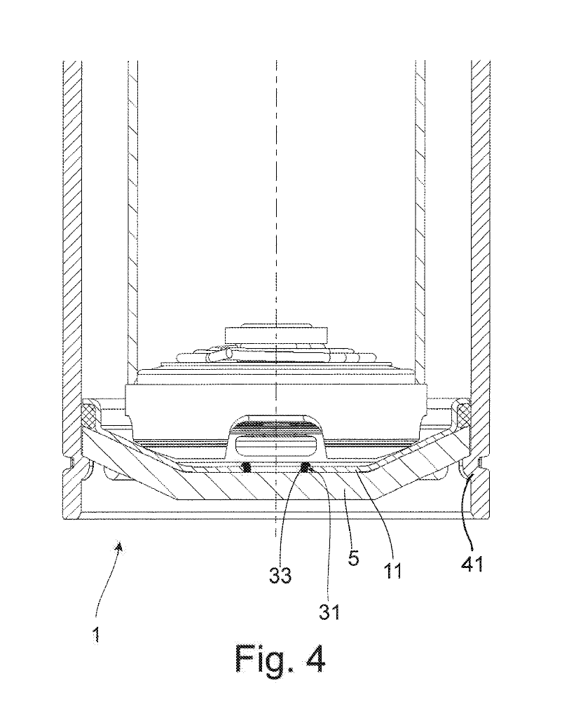

In FIG. 4, the disk element 11 has a through-opening 31 in the central area 23 receiving a solder volume 33 for connecting to the bottom 5. It is important only that the solder volume 33 connects the disk element 11 to the bottom 5 along the edge of the through-opening 31. The through-opening 31 need not be filled completely. The solder volume 33 prevents leakiness between the disk element 11 and the bottom 5 via the through-opening 31.

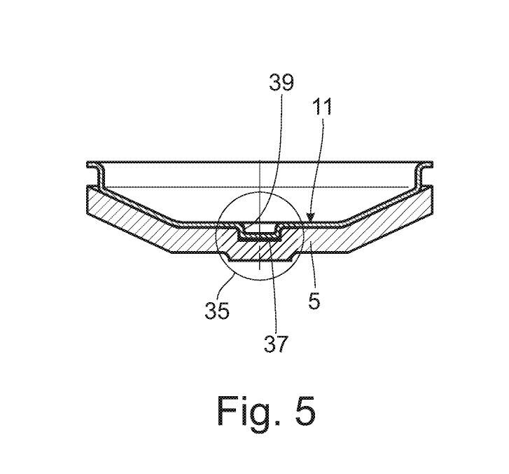

In the construction according to FIG. 5, the disk element 11 forms a constructional unit with the bottom 5 via a positive engagement connection 35. In this regard, the bottom 5 can have a small depression 37 on the inner side into which a shaping area 39 of the disk element 11 can extend. As has already been repeatedly mentioned, the requirements for the hold-together force of the positive engagement connection 35 are minimal.

During assembly of the cylinder unit 1, the constructional unit comprising bottom 5 and disk element 11 is produced beforehand. The annular seal 7 is inserted into the annular groove 9 subsequently. This constructional unit is inserted into the cylinder 3 via the end of the cylinder 3 closest to the end position of the bottom 5 and fixes bottom 5 via a plurality of bead portions 41 or also via a circumferential bead. The type and shape of positive engagement connection between the bottom and the cylinder is of secondary importance for this invention (FIGS. 1 and 2).

Subsequently, a pressure tube 43 with a bottom valve 45 already fixed at the end side is guided into the cylinder 3 until an underside of a bottom valve body 47 comes in abutting contact at least partially with an upper side of the disk element 11. In the further course of production, the pressure tube 43 is fixed relative to the cylinder 3 in that, e.g., a piston rod guide, not shown, as part of a vibration damper is placed on an end face oriented to the other end of the pressure tube, and the outer cylinder is in turn connected to the piston rod guide so as to be free from play axially. The disk element 11 is also accordingly fixed to the bottom 5 via the fixing of the bottom valve without still requiring fastening between the bottom 5 and the disk element 11.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed:

1. A cylinder unit comprising:
a cylinder;
a separate bottom closing the cylinder;
a disk element connected to the bottom;
an annular groove;
an annular seal fixed to the cylinder by the disk element and accommodated in the annular grove; the bottom forming a first groove side surface of the annular groove and the disk element forming a second groove side surface of the annular groove.

2. The cylinder unit according to claim 1, wherein the disk element forms a groove base of the annular groove.

3. The cylinder unit according to claim 1, wherein the annular groove has a trapezoidal cross section.

4. The cylinder unit according to claim 2, wherein the disk element comprises a surface area and wherein the disk element is connected over the entire surface area to the bottom radially inside the groove base of the annular groove.

5. The cylinder unit according to claim 1, wherein the disk element is adapted to a conical inner profile of the bottom.

6. The cylinder unit according to claim 1, wherein the disk element comprises a weldable material and is spot welded to the bottom.

7. The cylinder unit according to claim 1, wherein the disk element comprises a plastic.

8. The cylinder unit according to claim 1, wherein the disk element has a through-opening which receives a solder volume for joining the disk element to the bottom.

9. The cylinder unit according to claim 1, wherein the disk element forms a constructional unit with the bottom via a positive engagement connection.

10. The cylinder unit according to claim 1, wherein the cylinder unit is constructed as a vibration damper including a bottom valve; and wherein the disk element is fixed to the bottom by the bottom valve.
